(19) United States
(12) Patent Application Publication
(10) Pub. No.: US 2016/0292191 A1
(43) Pub. Date: Oct. 6, 2016

(54) DATA ARCHIVE SYSTEM

(71) Applicant: Hitachi-LG Data Storage, Inc., Tokyo (JP)

(72) Inventors: Hajime MORI, Tokyo (JP); Masayuki KOBAYASHI, Tokyo (JP); Tsukasa SHIBAYAMA, Tokyo (JP); Kohei TATARA, Tokyo (JP)

(21) Appl. No.: 15/045,492

(22) Filed: Feb. 17, 2016

(30) Foreign Application Priority Data
Mar. 30, 2015 (JP) 2015-067921

(51) Int. Cl. G06F 17/30; H04L 29/08

(52) U.S. Cl. CPC G06F 17/30309; H04L 67/1097

(57) ABSTRACT

A server control unit controls data library devices each having cartridges which can be attached and detached, by using a first information table in which fault information concerning abnormal operations of the data library devices is registered and a second information table in which position information of the recording media is registered. In a case where the server control unit has identified a first one of the data library devices that cannot be controlled on the basis of the first information table, the server control unit determines whether a recording media storage unit can be detached from the first data library device.

### INCORPORATION BY REFERENCE

The present application claims priority from Japanese application JP2015-067921 filed on Mar. 30, 2015, the content of which is hereby incorporated by reference into this application.

### BACKGROUND OF THE INVENTION

The present invention relates to a data archive system.

In a portable storage device utilizing portable storage media, which can be freely detached from the device and freely attached to the device, such as tape or an optical disc, storage media provided to a user as a storage area and utilized for data storage can be detached and exchanged. When storing data, it is also possible to write data directly into the portable storage media. However, it is also possible to store the data into a cache once and then move the data to the portable storage media. Such a technique is described in WO2007/075570A1.

On the other hand, a technique for instructing a restoration method on the basis of information indicating the degree of emergency of a fault and information indicating the degree of influence of restoration from a fault, as a support for restoration from a fault in an information processing device is described in JP-A-2009-211618.

### SUMMARY OF THE INVENTION

In a case where a fault has occurred in a portable storage device in a system including at least one portable storage devices and a control server, a system manager or a fault notice function in the system notifies a maintenance person of the occurrence of the fault. Upon being notified of the fault occurrence, the maintenance person arrives at a field where the system is installed and repairs the portable storage device. As a result, the system is restored from the fault. During a time period between the fault occurrence and completion of repair for the fault conducted by the maintenance person, the system has a problem that access of users to user data is stopped and the performance is degraded.

An object of the present invention is to provide a technique that makes it possible for a computer system to continue service to users until a maintenance person repairs a portable storage device when a fault has occurred in a system including at least one portable storage devices.

In order to solve the problem, for example, a configuration stated in claims is adopted.

The present invention provides a data archive system shortened in down time caused by a fault and having high availability by causing the system to continue access to user data stored in a portable storage device in which a fault has occurred.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of a configuration of an entire system according to the present invention;

FIG. 2A shows an example of an exterior view (front view) of a data library device 101;

FIG. 2B shows an example of an exterior view (side view) of the data library device 101;

FIG. 3 is a block diagram showing an example of a configuration example of a server 115;

FIG. 4 shows an example of a data library device management table 313 in the server 115;

FIG. 5 shows an example of a data library device fault state table 314 in the server 115;

FIG. 6 shows an example of a data read/write job management table 315 in the server 115;

FIG. 7 shows an example of a maintenance component table 316 in the server 115;

FIG. 8 shows an example of a maintenance schedule table 317 in the server 115;

FIG. 9 shows an example of a cartridge pulling out management table 318 in the server 115;

FIG. 10 shows an example of a user notice management table 319 in the server 115;

FIG. 11 is a flow diagram showing an example of pulling out and replacement determination processing of a cartridge 107;

FIG. 12 is a flow diagram showing an example of pulling out and replacement determination processing of the cartridge 107;

FIG. 13 is a flow diagram showing an example of processing of determining propriety of pulling out and replacing the cartridge 107 on the basis of a position of an optical disc 108;

FIG. 14 is a flow diagram showing an example of processing of determining whether there is a cartridge slot 102 of replacement destination;

FIG. 15 shows an example of the cartridge pulling out management table 318 in the server 115;

FIG. 16 shows an example of the user notice management table 319 in the server 115;

FIG. 17 is a flow diagram showing an example of processing of determining propriety of pulling out and replacing the cartridge 107 on the basis of a position and a state of an optical disc 108;

FIG. 18 shows an example of a preventive maintenance information table in the server 115; and

FIG. 19 is a flow diagram showing an example of processing of determining propriety of pulling out and replacing the cartridge 107 on the basis of a position and preventive maintenance information of an optical disc 108.

### DETAILED DESCRIPTION OF THE EMBODIMENTS

Embodiments of the present invention will now be described with reference to the drawings.

### Embodiment 1

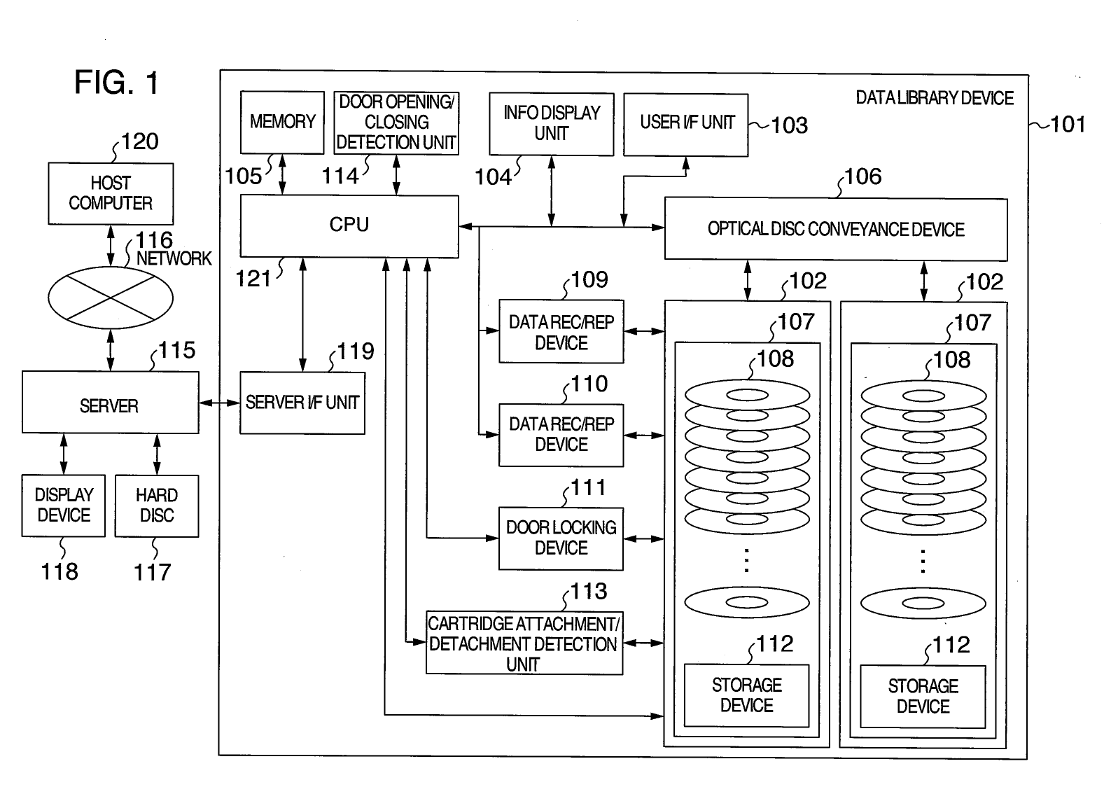

FIG. 1 is a block diagram showing a configuration of a data archive system.

In the present system, at least one server 115 and host computer 120 are connected via a network 116, such as a wired/wireless LAN (Local Area Network), a WAN (Wide Area Network), or an optical cable. A hard disc 117, a display device 118, and a data library device 101 are connected to the server 115. By the way, plural hard discs 117 and library devices 101 may be connected.

The data library device 101 is an example of a storage device including a portable storage device. The portable storage device includes a CPU (Central Processing Unit) 121, a user OF (interface) unit 103, an information (info) display unit 104, a memory 105, an optical disc conveyance device 106, at least one cartridge 107, at least one cartridge slot 102, at least one optical disc 108 stored in the cartridge 107, at least one data recording/reproducing (rec/rep) device (in FIG. 1, two data recording/reproducing devices 109 and 110), a door locking device 111, a storage device 112, a cartridge attachment/detachment detection unit 113, a door opening/closing detection unit 114, and a server I/F unit 119.

At the time of recording, the data library device 101 receives an instruction of data recording from the server 115, receives data to be recorded, and records the received data onto optical discs 108a and 108b. At the time of reproducing, the data library device 101 receives an instruction of data reproduction, reproduces data from the optical discs 108a and 108b, and delivers the data to the server 115.

The CPU 121 manages the data library device 101 besides the data recording and data reproducing in accordance with various commands from the server 115. In response to a request from the server 115, the CPU 121 controls the optical disc conveyance device 106, selects desired optical discs from among a plurality of optical discs 108a and 108b stored in cartridges 107a and 107b, and sends the optical discs to the data recording/reproducing devices 109 and 110. Furthermore, the CPU 121 controls the optical disc conveyance device 106, receives optical discs from the data recording/reproducing devices 109 and 110, and stores the optical discs into predetermined positions in the cartridges 107a and 107b.

Furthermore, in response to a request from the server 115, the CPU 121 conducts information giving and receiving with storage devices 112a and 112b, acquires management information of the data library device 101, and conducts information giving and receiving with the server 115. For example, the CPU 121 acquires information detected by the cartridge attachment/detachment detection unit 113 and the door opening/closing detection unit 114, and notifies the server 115 of the information. Furthermore, the CPU 121 controls the data library device 101 on the basis of an instruction from the server 115 or the acquired management information of the data library device 101.

In addition, the CPU 121 always monitors a fault in each of portions of the data library device 101. Upon detecting a fault, the CPU 121 notifies the server 115 of fault information, and controls the data library device 101 on the basis of an instruction from the server 115 or the detected fault information.

A fault of the data library device 101 monitored by the CPU 121 occurs in a case where a portion of the data library device 101 performs an abnormal operation that is not supposed or software that operates in the data library device 101 performs an abnormal operation that is not supposed. A fault of the CPU 121 may be monitored by the CPU 121 itself, may be monitored by a CPU 121 in other data library device 101, or may be monitored by the server 115.

For example, an example of a case where a fault has occurred in the optical disc conveyance device 106 in the data library device 101 will now be described. The CPU 121 issues a command for controlling the optical disc conveyance device 106 in the data library device 101. In a case where there is no response from the optical disc conveyance device 106 with respect to the command or there is a response indicating an abnormality, the CPU 121 detects occurrence of a fault in the optical disc conveyance device 106. Then, the CPU 121 notifies the server 115 of fault information based on a response result from the optical disc conveyance device 106. The server 115 issues processing based on the fault information to the CPU 121. For example, in a case where there is no response to the CPU 121 from the optical disc conveyance device 106 and the optical disc conveyance device is blocked, the server 115 stops an instruction of data recording or data reproducing to the data library device 101. In addition, the server 115 instructs the CPU 121 to exhibit a display on the information display unit 104 to indicate the occurrence of a fault in the optical disc conveyance device 106.

Then, the user I/F unit 103 provides means used by the user to operate the data library device 101, such as various switches. The information display unit 104 outputs various kinds of information, such as a work situation of the data library device 101, to an internal or external liquid crystal display or LED (Light Emitting Diode). The memory 105 stores various programs and various kinds of information. For example, a program and setting information for controlling the CPU 121 in the data library device 101 are also stored in the memory 105.

Under control of the CPU 121 in the data library device 101, the optical disc conveyance device 106 takes out the optical discs 108a and 108b from the cartridges 107a and 107b, conveys the optical discs 108a and 108b, and loads the optical discs 108a and 108b into the data recording/reproducing devices 109 and 110. Or the optical disc conveyance device 106 receives the optical discs 108a and 108b from the data recording/reproducing devices 109 and 110, conveys the optical discs 108a and 108b, and stores the optical discs 108a and 108b into the cartridges 107a and 107b. The cartridges 107a and 107b include a plurality of optical discs 108a and 108b. Furthermore, the cartridges 107a and 107b can be attached and detached with the optical discs 108 stored therein.

For example, if it is finished to record data on all optical discs, it is possible to take out the cartridge 107 as a whole to the outside of the cartridge slot 102 in the data library device 101 and instead put a different cartridge 107 storing unrecorded optical discs 108 into the cartridge slot 102 in the data library device 101.

By the way, only two cartridges 107 and only two cartridge slots 102 are shown in FIG. 1. However, three or more cartridges 107 and three or more cartridge slots 102 may be included in the data library device 101. Or only one cartridge 107 and only one cartridge slot 102 may be included in the data library device 101. There may be a state in which any cartridge 107 does not exist in the cartridge slot 102. Furthermore, the cartridges may be used properly according to uses. For example, it is possible to use one of the cartridges for unrecorded discs and use the other of the cartridges for recorded discs. Or the cartridges may be used properly according to disc classifications. For example, it is possible to use one of the cartridges for discs that are recordable on one side and use the other of the cartridges for discs that are recordable on both sides. As a matter of course, the inside of each of the cartridges 107a and 107b may be partitioned to an unrecorded disc storage area and a recorded disc storage area.

A plurality of optical discs 108a and a plurality of optical discs 108b are stored within the cartridges 107a and 107b, respectively. At the time of data recording, optical discs are taken out from the cartridges 107a and 107b by the optical disc conveyance device 106, and loaded into the data recording/reproducing devices 109 and 110. If data recording is finished, the optical discs are returned to the cartridges 107a and 107b by the optical disc conveyance device 106. On the other hand, at the time of data reproducing, the optical discs 108a and 108b are taken out from the cartridges 107a and 107b by the optical disc conveyance device 106, and loaded into the data recording/reproducing devices 109 and 110 to reproduce data. If data reproducing is finished, the optical discs 108a and 108b are returned to the cartridges 107a and 107b by the optical disc conveyance device 106.

By the way, in FIG. 1, two data recording/reproducing devices are mounted on the data library device 101. However, the number of mounted data recording/reproducing devices is not restricted. For example, six data recording/reproducing devices may be mounted.

At the time of data recording or data reproducing, the optical discs 108a and 108b move within the data library device 101 under the control of the CPU 112, which has received an instruction from the server 115. As a result, the storage position of the optical disc 108 is different. For example, as for the optical disc 108, there are a state in which the optical disc 108 is loaded in the data library device 101 and stored within the cartridge 107a or 107b, a state in which the optical disc 108 is stored within the optical disc conveyance device 106, and a state in which the optical disc 108 is stored in the data recording/reproducing device 109 or 110. At this time, the CPU 112 notifies the server 115 of information concerning the latest storage positions of the optical discs 108a and 108b. The CPU 112 may store information of the storage positions of the optical discs 108a and 108b into the memory 105.

Although not illustrated, the data library device 101 may include a measurement portion that can pick information of storage positions of the optical discs 108a and 108b and determine the storage positions of the optical discs 108a and 108b on the basis of information from the measurement portion.

The storage devices 112a and 112b store information concerning the cartridges 107 and information required to control the cartridges 107. The cartridge attachment/detachment detection unit 113 detects attachment/detachment of the cartridges 107a and 107b to/from the cartridge slots, and transmits detected information to the CPU 121. The door opening/closing detection unit 114 detects opening/closing of a door included in the data library device 101 to attach/detach the cartridge 107, and transmits detected information to the CPU 121. The door locking device 111 conducts unlocking and locking of the door by using a lock disposed on the door included in the data library device 101 under control of the CPU 121. Although not illustrated, the lock may have a mechanism capable of controlling the unlocking and locking of the door manually besides control exercised by the door locking device 111. The server I/F unit 119 transmits/receives data, such as data to be recorded, reproduced data, various control commands, and management information, between the server 115 and the data library device 101.

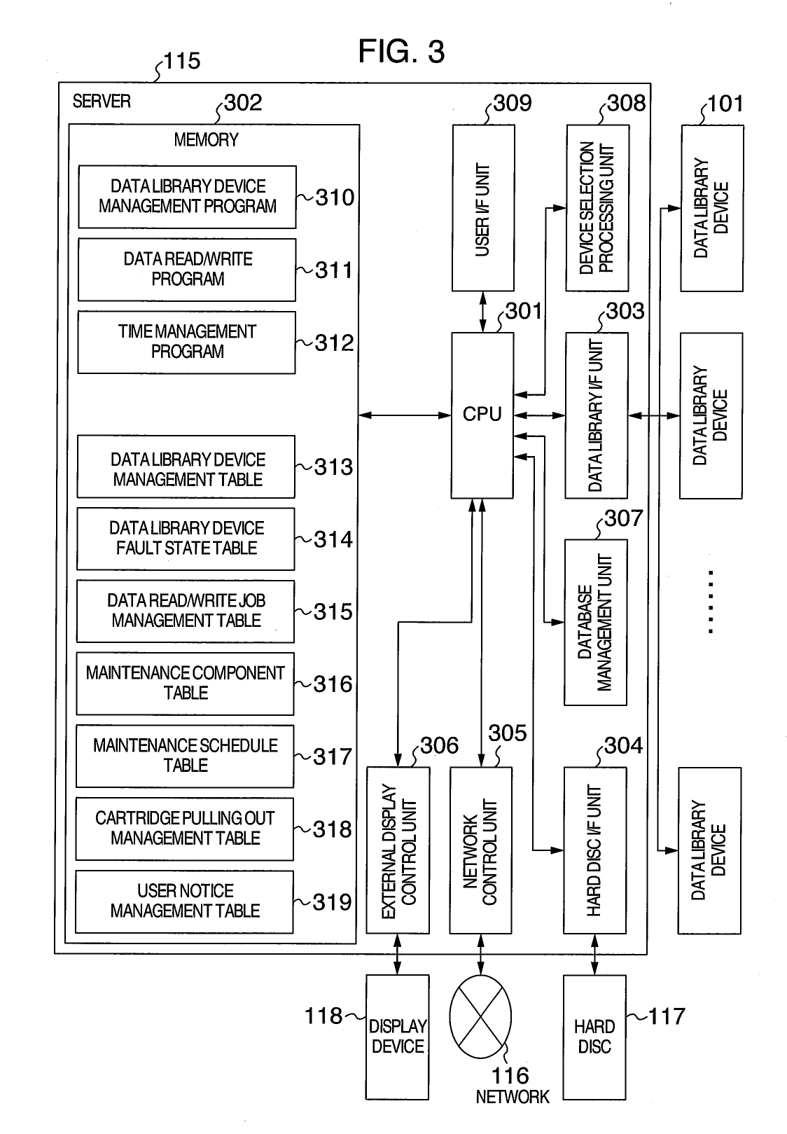

The server 115 communicates with the CPU 121 via the server I/F unit 119 in at least one data library device 101 to control the data library device 101. Furthermore, the server 115 conducts data management via the hard disc 117, and conducts information display via the display device 118. The server 115 also controls transmission/reception of data and information to/from other devices connected via the network 116, for example, the host computer 120. By the way, details of the server 115 will be described later with reference to FIG. 3.

Reference numeral 116 denotes a network. A plurality of servers 115, host computers 120, and the like are connected to the network 116. Reference numeral 117 denotes a hard disc. The hard disc 117 stores data and information concerning control of the data archive system. Reference numeral 118 denotes a display device. The display device 118 displays information concerning the server 115, or information concerning the data library device 101 or the hard disc 117 connected to the server 115.

Reference numeral 120 denotes a host computer. The host computer 120 executes user's data writing and reading processing with respect to the server 115. Upon receiving data writing and reading processing from the host computer 120, the server 115 issues a data recording or data reproducing instruction to at least one data library device 101. The host computer 120 is, for example, an ordinary computer mounting archive software.

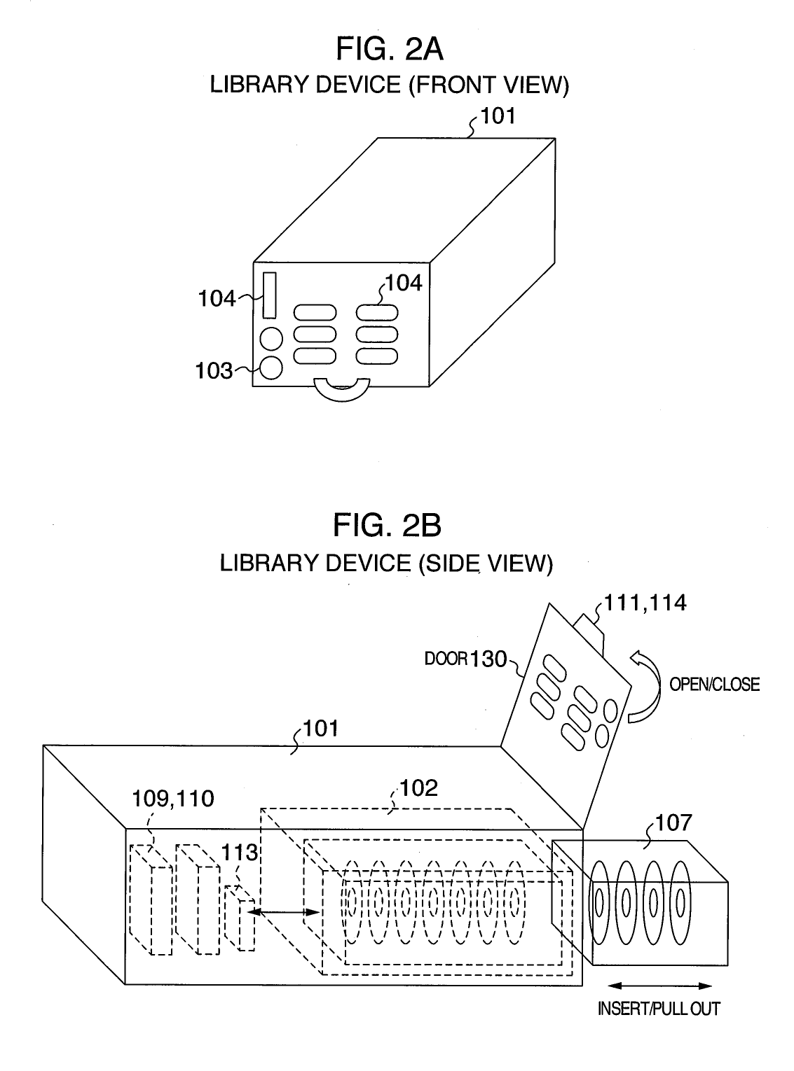

FIGS. 2A and 2B show an example of an exterior view of the data library device 101. FIG. 2A is a front view, and FIG. 2B is a side view. It becomes possible to insert/pull out the cartridge 107 into/from the cartridge slot 102 stored within the data library device 101 by opening the door 130.

FIG. 3 is a block diagram showing a configuration of the server in the data archive system. At least one data library device 101, the network 116, the hard disc 117, and the display device 118 are connected to the server 115. The server 115 is configured to include a CPU 301, a memory 302, a data library I/F unit 303, a hard disc I/F unit 304, a network control unit 305, an external display control unit 306, a database management unit 307, a device selection processing unit 308, and a user I/F unit 309.

At the time of data recording, the CPU 301 records data received from the host computer 120 via the network 116 by the network control unit 305, onto the hard disc 117 via the hard disc I/F unit 304. Or the CPU 301 controls the data library device 101 via the data library I/F unit 303, and records the data onto an optical disc incorporated in the data library device 101. At the time of data reproducing, the CPU 301 reads out data from the hard disc 117 via the hard disc I/F unit 304, and transmits the data read out, from the network control unit 305 to the host computer 120 via the network 116.

Or the CPU 301 controls the data library device 101 via the data library I/F unit 303, reproduces data from the optical disc 108 incorporated in the data library device 101, receives the reproduced data, and transmits the received data, from the network control unit 305 to the host computer 120 via the network 116.

Furthermore, the CPU 301 processes suitably various kinds of information received from the data library device 101, and records and manages resultant information. The CPU 301 reproduces the resultant information, determines a control plan on the basis of the reproduced information, and exercises actual control. In addition, the CPU 301 displays information on the display device 118 via the external display control unit 306.

Various kinds of information, such as a program for controlling the CPU 301 in the server 115 and management information of the server 115, are recorded in the memory 302. Furthermore, management information or the like of the data library device 101 notified by the CPU 112 in the data library device 101 is stored in the memory 302. For example, storage position information of the optical discs 108, and fault information, heat information, and vibration information of the data library device 101 are stored in the memory 302. By the way, these kinds of information may be stored in the memory 302 or the hard disc 117 by the database management unit 307 described later.

The memory 302 includes therein a data read/write program 311, a data library device management program 310, a time management program 312, a data library device management table 313, a data library device fault state table 314, a data read/write job management table 315, a maintenance component table 316, a maintenance schedule table 317, a cartridge pulling out management table 318, and a user notice management table 319. By the way, data within the memory 302 may be stored in the memory 302 or the hard disc 117 by the database management unit 307.

The data read/write program 311 is executed by the CPU 301. The data read/write program 311 receives write data from the host computer 120 and executes processing of recording data onto the hard disc 117 or the optical disc 108 in the data library device 101. Furthermore, the data read/write program 311 receives data read from the host computer 120 and executes processing of reproducing data recorded on the hard disc 117 or the optical disc 108 in the data library device 101 and returning a result to the host computer 120.

The data library device management program 310 is executed by the CPU 301 to execute processing of managing at least one data library device 101 connected to the server 115. The data library device management program 310 executes processing of storing various kinds of information notified by the data library device 101 into the memory 302 or onto the hard disc 117. In addition, the data library device management program 310 executes processing of controlling the server 115 and the data library device 101 on the basis of the various kinds of information. Furthermore, the data library device management program 310 executes processing of controlling the server 115 and the data library device 101 on the basis of a command input by the user I/F unit 309.

Furthermore, the data library device management program 310 executes processing of controlling the server 115 and the data library device 101 on the basis of a command received from the host computer 120. In addition, the data library device management program 310 executes processing of displaying a result of the control on the external display control unit 306 or returning the result of the control to the host computer 120.

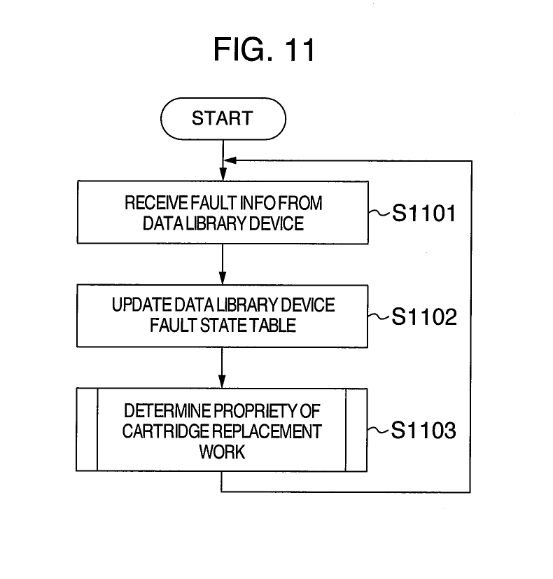

By the way, details of the data library device management program 310 according to the present invention will be described every processing step with reference to FIGS. 11, 12, 13 and 14 described later. The time management program 312 is executed by the CPU 301 to manage the time in the server 115. Although not illustrated, current time is stored in the memory 302. By the way, time may be stored by communicating with a time management server external to the server 115.

The data library device management table 313 is a data table utilized by the data library device management program 310. The data library device management table 313 stores information concerning at least one data library device 101 managed by the server 115.

The data library device fault state table 314 is a data table utilized by the data library device management program 310. The data library device fault state table 314 stores information concerning a fault in the data library device 101 notified by at least one data library device 101 managed by the server 115.

The data read/write job management table 315 is a data table utilized by the data library device management program 310 and the data read/write program 311. The data read/write job management table 315 stores scheduled information of processing of data recording or data reproducing issued to at least one data library device 101 managed by the server 115.

The maintenance component table 316 is a data table utilized by the data library device management program 310. The maintenance component table 316 stores information concerning maintenance components of the server 115 and the data library device 101.

The maintenance schedule table 317 is a data table utilized by the data library device management program 310. The maintenance schedule table 317 stores information concerning a maintenance contract of the server 115 and the library device 101 and estimated time required until restoration from a fault of the data library device 101.

The cartridge pulling out management table 318 is a data table utilized by the data library device management program 310. The cartridge pulling out management table 318 stores optical disc storage position information of the cartridge 107 in a data library device 101 in which a fault has occurred among at least one data library devices 101 managed by the server 115, and attachment/detachment propriety information.

The user notice management table 319 is a data table utilized by the data library device management program 310. The user notice management table 319 stores information to be notified to the user.

Details concerning the data tables described heretofore will be described later. The data library I/F unit 303 exercises control concerning data transmission/reception conducted between the data library device 101 and the CPU 301 in the server 115. Although a plurality of data library devices 101 are connected to one data library I/F unit in FIG. 3, for example, a configuration in which a plurality of data library devices are connected via a network may also be used.

The hard disc I/F unit 304 conducts data transfer based upon standards such as SATA (Serial Advanced Technology Attachment), with the hard disc 117. The network control unit 305 exercises control concerning data transmission/reception conducted between the network 116 and the CPU 301 in the server 115.

The database management unit 307 takes charge of access to a database in which various kinds of information used to control the data archive system are recorded. Specifically, the database management unit 307 conducts processing such as registration of information into the database, reading registered information, and retrieval of registered information. By the way, the database management unit 307 in the present embodiment determines whether it is necessary to newly create or update a database in order to control the system and determines which information is to be registered. Essential manipulation and management of the database are entrusted to the CPU 301. However, essential manipulation and management of the database are not restricted to the CPU 301, but the database management unit 307 may conduct essential manipulation and management of the database. By the way, the database is stored in the memory 302 or the hard disc 117.

When recording or reproducing data, the device selection processing unit 308 determines or selects which of at least one data library device connected to the server, determines or selects which of at least one data recording/reproducing device incorporated in the selected data library device, and selects an optical disc to be recorded or reproduced. The user I/F unit 309 provides a means for the user to control the server and control each data library device via the server on the basis of various kinds of information displayed on the display device 118.

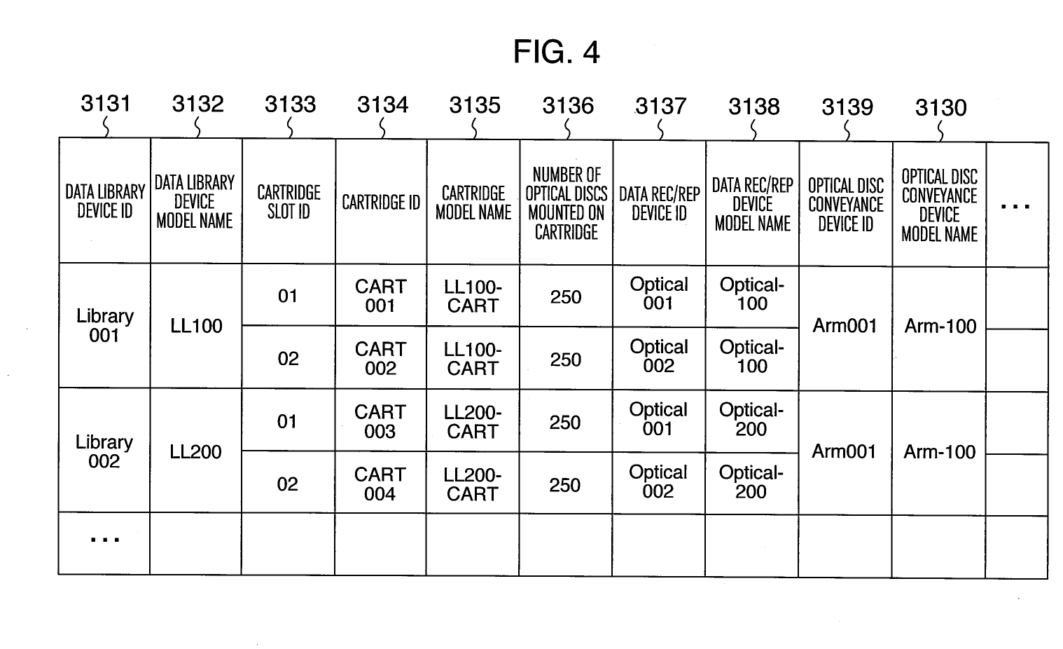

FIG. 4 shows an example of the data library device management table 313. The data library device management table 313 includes a data library device ID 3131, a data library device model name 3132, a cartridge slot ID 3133, a cartridge ID 3134, a cartridge model name 3135, a number of optical discs mounted on cartridge 3136, a data recording/reproducing device ID 3137, a data recording/reproducing device model name 3138, an optical disc conveyance device ID 3139, and an optical disc conveyance device model name 3130.

The data library device ID 3131 is an identifier unique to the data library device 101 set at the time of product shipping. The data library device model name 3132 is a model name or a type name determined by a vendor of the data library device 101. The cartridge slot ID 3133 is an identifier unique to the cartridge slot 102. The cartridge slot ID 3133 is determined uniquely every data library device 101 incorporating the cartridge slot 102. In the present embodiment, one data library device 101 is supposed to have two cartridge slots 102. However, this shall not always apply. The cartridge ID 3134 is an identifier unique to the cartridge 107 which is set at the time of product shipping of the cartridge 107 inserted into the cartridge slot 102 of the data library device 101. In a case where there is no cartridge 107 inserted into the cartridge slot 102 of the data library device 101, information that the cartridge 107 is not yet inserted is stored. In the present embodiment, it is supposed that one cartridge 107 can be inserted into one cartridge slot 102. However, this shall not always apply. The cartridge model name 3135 is a model name or a type name determined by a vendor of the cartridge 107 of the cartridge ID 3134. The number 3136 of optical discs mounted on cartridge is the number of optical discs 108 loaded in the cartridge 107 having the cartridge ID 3134.

The data recording/reproducing device ID 3137 is an identifier unique to each of the data recording/reproducing devices 109 and 110. The data recording/reproducing device ID 3137 is determined uniquely every data library device 101 incorporating the data recording/reproducing devices 109 and 110. The data recording/reproducing device model name 3138 is a model name or a type name determined by a vendor of the data recording/reproducing devices 109 and 110. The optical disc conveyance device ID 3139 is an identifier unique to the optical disc conveyance device 106. The optical disc conveyance device ID 3139 is determined uniquely every data library device 101 incorporating the optical disc conveyance device 106. The optical disc conveyance device model name 3130 is a model name or a type name determined by a vendor of the optical disc conveyance device 106.

In the present embodiment, optical discs of the same classification are loaded into the cartridge. However, this shall not always apply. In that case, the number 3136 of optical discs mounted on cartridge may hold information, such as an optical disc model name and the number of optical discs, of every classification of optical discs loaded in the cartridge 107.

As for the data library device management table 313, when at least one data library device 101 managed by the server 115 is started or a device configuration is changed, the data library device 101 notifies the server 115 of the data library device 101 and the data library device management table 313 is changed. Or the server 115 inquires of the data library device 101 periodically and the data library device management table 313 is always held in the latest state.

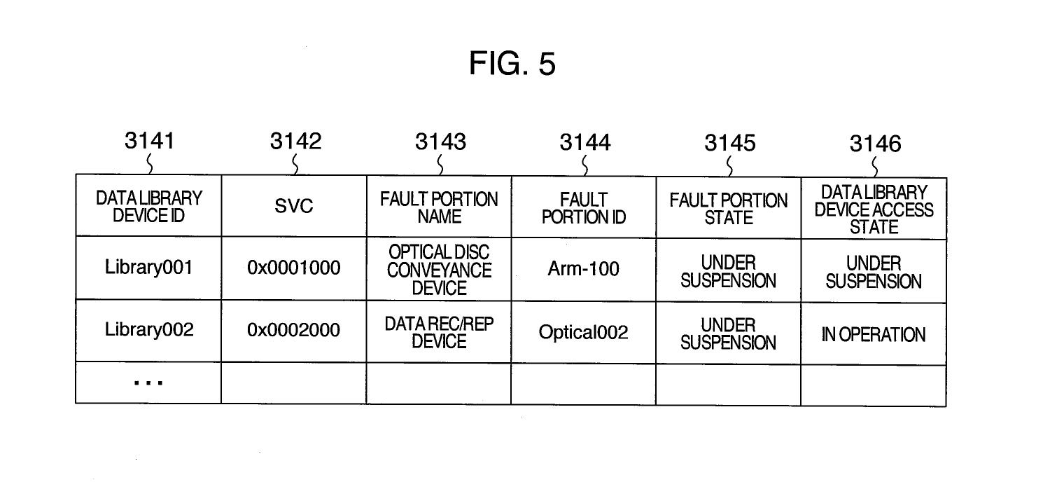

FIG. 5 shows an example of the data library device fault state table 314. The data library device fault state table 314 includes a data library device ID 3141, an SVC (Service Code) 3142, a fault portion name 3143, a fault portion ID 3144, a fault portion state 3145, and a data library device access state 3146.

The data library device ID 3141 stores an identifier unique to the data library device 101 set at the time of product shipping. The SVC 3142 stores a value determined uniquely according to a fault portion and a fault cause of the data library device 101 and set by a vendor previously. On the basis of the SVC, the user and maintenance person can confirm a fault in the data library device 101 and determine contents of maintenance work. The fault portion name 3143 stores a name of a portion where a fault has occurred among names of portions included in the data library device 101. The fault portion ID 3144 stores an unique identifier of a portion where a fault has occurred among unique identifiers of portions included in the data library device 101. The fault portion state 3145 stores state information of a portion of the data library device 101 where a fault has occurred. The data library device access state 3146 stores information as to whether data reproducing or data recording requested to the data library device 101 by the server 115 is possible in a state in which a fault has occurred in the fault portion.

In the present embodiment, the data library device access state 3146 stores “under suspension” in a case where data reproducing or data recording cannot be conducted from the server 115. In a case where data reproducing or data recording can be conducted from the server 115, the data library device access state 3146 stores “in operation.”

As for the data library device fault state table 314, when a fault has occurred in at least one data library device 101 managed by the server 115, the data library device 101 notifies the server 115 of a value to be stored in the data library device fault state table 314 and the data library device fault state table 314 is changed. Or the server 115 inquires of the data library device 101 periodically and the data library device fault state table 314 is always held in the latest state.

As for the SVC 3142, the server 115 notified of a fault portion and a fault cause as fault information by the data library device 101 may generate the SVC 3142.

As for the data library device access state 3146, the server 115 may issue an instruction of data recording or data reproducing to the data library device 101 and store a result thereof. Or the data library device 101 itself may diagnose propriety of data recording or data reproducing on the basis of fault information, and notify the server 115 of a result of the diagnosis to store the result. Or the server 115 may diagnose propriety of data recording or data reproducing on the basis of fault information notified by the data library device 101 and store a result.

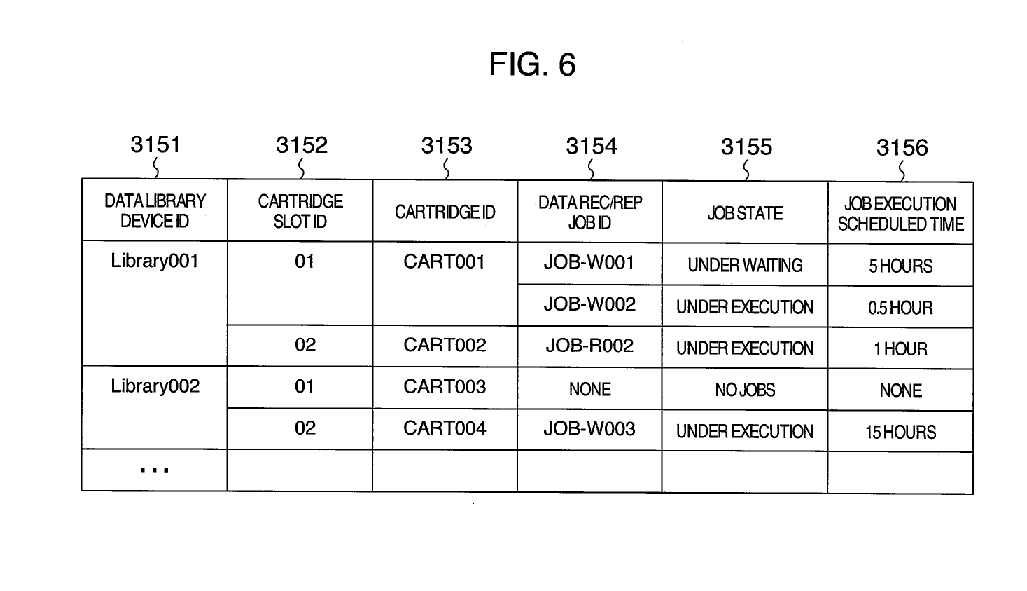

FIG. 6 shows an example of the data read/write job management table 315. The data read/write job management table 315 includes a data library device ID 3151, a cartridge slot ID 3152, a cartridge ID 3153, a data recording/reproducing job ID 3154, a job state 3155, and a job execution scheduled time 3156.

The data library device ID 3151 stores an identifier unique to the data library device 101 set at the time of product shipping. The cartridge slot ID 3152 stores an identifier unique to the cartridge slot 102. The cartridge slot ID 3152 is determined uniquely every data library device 101 incorporating the cartridge slot 102. The cartridge ID 3153 stores an identifier unique to the cartridge 107 set at the time of product shipping. The data recording/reproducing job ID 3154 is an unique identifier of an instruction of data reading or data writing which is notified to data read/write program 311 in the server 115 by the host computer 120. The data recording/reproducing job ID 3154 is stored in the data read/write job management table 315 as a job every data recording/data reproducing onto/from the optical disc 108 in the data library device 101.

In the present embodiment, a job is assigned every cartridge 107. However, this shall not always apply. For example, the unit may be at least one optical disc. Or at least one cartridge may be collected as a logical group and set as a job assignment unit.

As for the data read/write program 311, the number of jobs that can be executed may be limited. At that time, each job is assigned an order. A job in a state waiting for execution of the job during data recording/data reproducing onto/from the optical disc 108 in the data library device 101 is stored in the job state 3155 as “under waiting.” For example, in the present embodiment, only two data recording/reproducing devices 109 and 110 in the data library device 101 can record/reproduce data onto/from the optical disc 108. Therefore, the number of jobs that can be executed at the same time is set to two in total in the two cartridges belonging to the same data library device 101. By the way, restrictions on the order of jobs to be executed and the number of jobs that can be executed at the same time are not restricted to those described above.

The job execution scheduled time 3156 stores an estimated value of time required between start and end of the job. The data read/write program 311 in the server 115 calculates the job execution scheduled time 3156 on the basis of, for example, the data quantity of data recording and data reproducing and resources in the data library device 101 that can be assigned.

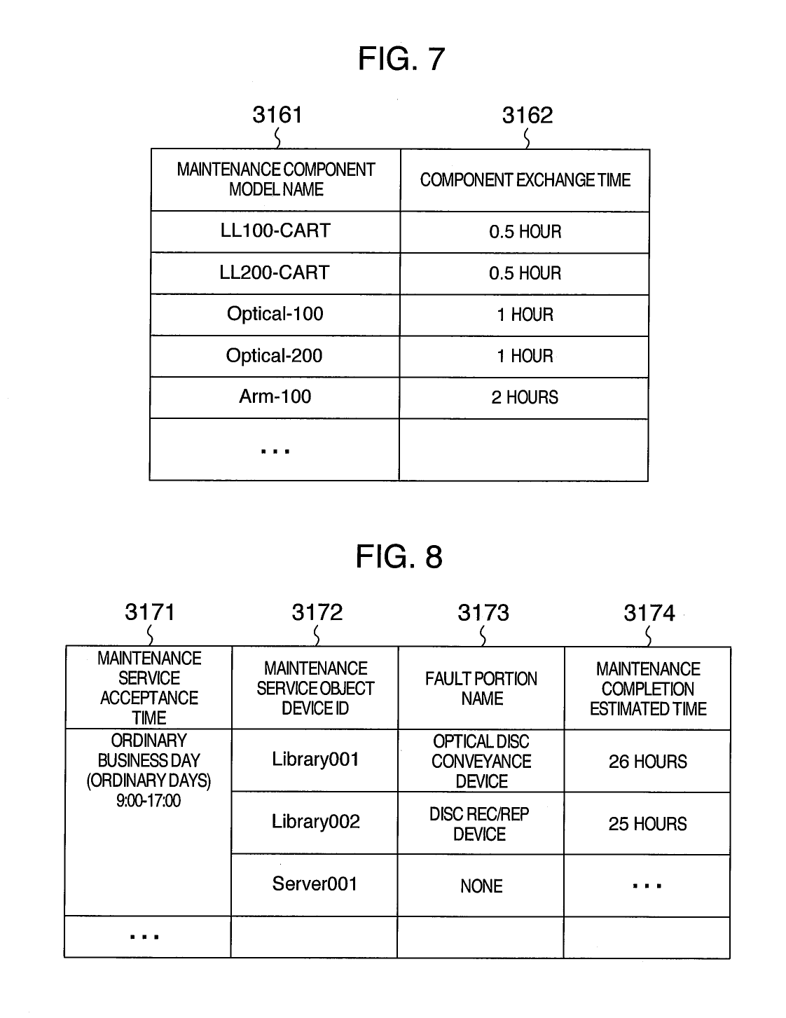

FIG. 7 shows an example of the maintenance component table 316. The maintenance component table 316 includes a maintenance component model name 3161 and a component exchange time 3162. The maintenance component model name 3161 stores a model name and a type name determined by a vendor. Maintenance component models prepared for maintenance are determined on the basis of model names or type names registered in the data library device management table 313. The component exchange time 3162 is time required for component exchange and determined by a vendor or a maintenance service corporation previously every maintenance component model name 3161. The maintenance component table 316 retains values for all maintenance object components included in the data library device 101 previously at the time of shipping.

FIG. 8 shows an example of the maintenance schedule table 317. The maintenance schedule table 317 includes a maintenance service acceptance time 3171, a maintenance service object device ID 3172, a fault portion name 3173, and a maintenance completion estimated time 3174.

The maintenance service acceptance time 3171 stores contents of maintenance service contracted between a customer and a store at the time of purchase of the data library device 101. For example, the maintenance service acceptance time 3171 stores a time zone during which the user can contact a maintenance person and time required since contact until the maintenance person reaches the front of the data library device 101. The maintenance service object device ID 3172 stores unique identifiers of devices that become objects of the maintenance service acceptance time 3171. The fault portion name 3173 is a name of each of portions included in the data library device 101 in the same way as the fault portion name 3143. The maintenance completion estimated time 3174 stores estimated time required until restoration from a fault is done in a case where the fault has occurred at current time. The estimated time here is time required for a user to contact a maintenance person, and for the maintenance person to arrive at the front of the library device 101 and completes exchange of a maintenance component. Values in the maintenance schedule table 317 are registered previously when the user and the vendor or maintenance service corporation contract a maintenance contract.

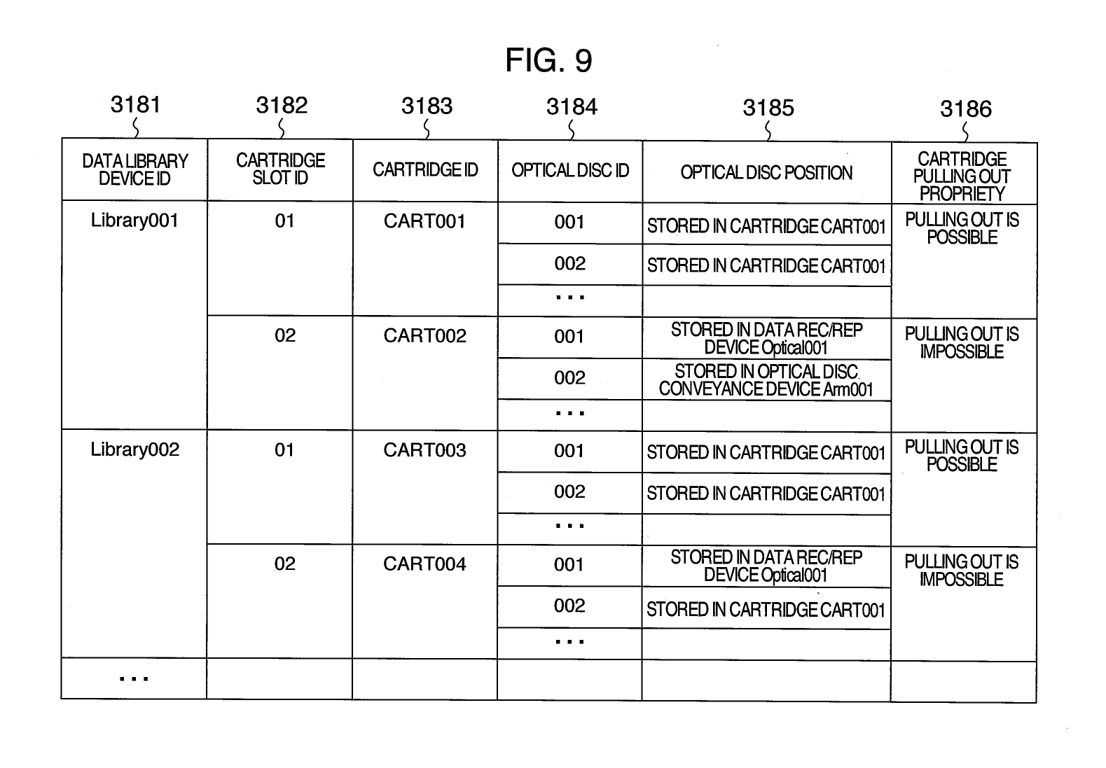

FIG. 9 shows an example of the cartridge pulling out management table 318. The cartridge pulling out management table 318 includes a data library device ID 3181, a cartridge slot ID 3182, a cartridge ID 3183, an optical disc ID 3184, an optical disc position 3185, and cartridge pulling out propriety 3186.

The data library device ID 3181 stores an unique identifier of a data library device set at the time of product shipping. The cartridge slot ID 3182 stores an unique identifier of the cartridge slot 102. The cartridge slot ID 3182 is determined uniquely every data library device 101 incorporating the cartridge slot 102. The cartridge ID 3183 stores an unique identifier of the cartridge 107 set at the time of product shipping.

The optical disc ID 3184 stores an unique identifier of the optical disc 108. The optical disc ID 3184 may store an unique identifier every cartridge ID 3183. The optical disc position 3185 stores information as to where in the data library device 101 the optical disc ID 3184 is stored. Although not illustrated in processing flows, the data library device 101 always monitors storage positions of optical discs in accordance with movement of optical discs for data reproducing and data recording and notifies the server 115 of the storage positions. As a result, the optical disc position 3185 is updated to latest information. Or the server 115 inquires of the data library device 101 periodically, and the optical disc position 3185 is always held in the latest state. The cartridge pulling out propriety 3186 stores a result of processing of determining propriety of pulling out the cartridge 107 described later.

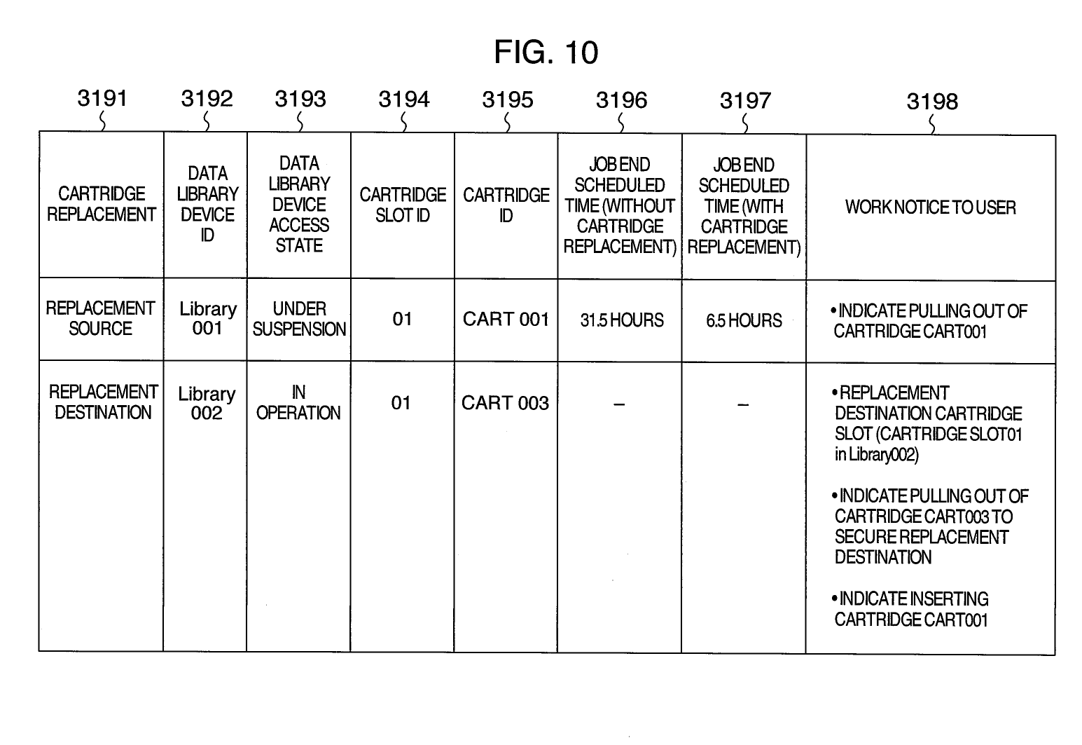

FIG. 10 shows an example of the user notice management table 319. The user notice management table 319 includes cartridge replacement 3191, a data library device ID 3192, a data library device access state 3193, a cartridge slot ID 3194, a cartridge ID 3195, a job end scheduled time (without cartridge replacement) 3196, a job end scheduled time (with cartridge replacement) 3197, and a work notice to user 3198.

The cartridge replacement 3191 stores information making a distinction whether the unique identifier of the cartridge slot 102 stored in the cartridge slot ID 3194 indicates a cartridge slot 102 through which the cartridge 107 is pulled out from a data library device in which a fault has occurred or indicates a cartridge slot 102 that is a replacement destination of the cartridge 107 pulled out. In the present embodiment, a cartridge slot 102 through which the cartridge 107 is pulled out from a data library device in which a fault has occurred is regarded as a replacement source. A cartridge slot 102 that is a replacement destination of the cartridge 107 pulled out is regarded as a replacement destination. The data library device ID 3192 stores an unique identifier of the data library device 101 set at the time of product shipping. The data library device access state 3193 stores information as to whether the server 115 can reproduce/record data from/into the data library device 101 in a state in which a fault has occurred in the library device 101.

In the present embodiment, the data library device access state 3193 stores “under suspension” in a case where data reproducing or data recording cannot be conducted from the server 115. In a case where data reproducing or data recording can be conducted from the server 115, the data library device access state 3193 stores “in operation.” The cartridge slot ID 3194 stores an unique identifier of the cartridge slot 102. The cartridge slot ID 3194 is determined uniquely every data library device 101 incorporating the cartridge slot 102. The cartridge ID 3195 stores an unique identifier of the cartridge 107 set at the time of product shipping. In a case where a cartridge is not inserted in the cartridge slot 102 in the data library device 101, information “not yet inserted” is stored. The job end scheduled time (without cartridge replacement) 3196 stores time required until all jobs assigned to the cartridge finish in a case where the user does not execute cartridge replacement work. The job end scheduled time (with cartridge replacement) 3197 stores time required until all jobs assigned to the cartridge finish in a case where the user executes cartridge replacement work. The job end scheduled time (without cartridge replacement) 3196 and the job end scheduled time (with cartridge replacement) 3197 may be stated every ID job.

The work notice to user 3198 stores contents of creation of a composition to be displayed on the display device 118 and to be understood by the user easily, based on information stored in the user notice management table 319. For example, in a case where the user notice management table 319 stores information concerning the cartridge slot 102 of the replacement source, contents of indicating cartridge pulling out work of the cartridge 107 in the cartridge slot 102 in the data library device 101 of the replacement source are generated as the work notice to user 3198. By the way, the user notice management table 319 itself may also be displayed.

FIG. 11 is a flow of processing executed by the data library device management program 310 in the server 115 at the time of operation of the data archive system in the present embodiment.

The processing flow in FIG. 11 is a processing flow of determining, when a fault has occurred in a data library device 101, whether to pull out a cartridge 107 in the data library device 101 in which the fault has occurred and replace a cartridge 107 in another data library device 101 operating normally with the cartridge 107 pulled out.

In step S1101, the server 115 receives fault information from the data library device 101 in which the fault has occurred. As the fault information, the server 115 is notified of a data library device ID set at the time of product shipping to determine the data library device 101 itself uniquely, a portion in which the fault has occurred (hereafter referred to as fault portion as well), a fault cause, a state of the fault portion, an access state of the data library device 101, and so on. For example, as for the fault occurrence portion, an ID of each device within the data library device 101 is notified. As for the fault cause, a cause of determination that a fault has occurred conducted by the data library device 101 is notified. For example, a temperature abnormality or the like is notified. As for the state of the fault occurrence portion, influence of the fault upon the fault portion is notified. For example, it is notified whether the fault occurrence portion is under suspension or in operation. As for the access state of the data library device 101, it is notified whether the server 115 can access the optical disc 108 under the fault.

Upon being notified of the fault information, the server 115 may determine the access state of the data library device 101. The fault information from the data library device 101 described above are only items relating to the present embodiment. Other information may be added.

In step S1102, the data library device management program 310 updates the data library device fault state table 314 on the basis of the fault information of the data library device 101 received in S1101. The data library device ID that has notified the fault information is registered in the data library device ID in the data library device management program 310. An error code for classifying a fault determined uniquely from the fault portion ID and the fault cause generated by the data library device management program 310 is registered in the SVC 3142. The name of the fault portion, the fault portion ID, the state of the fault portion, and the access state of the data library device are registered in the data library device fault state table 314 on the basis of fault information of the data library device 101 received in S1101, respectively.

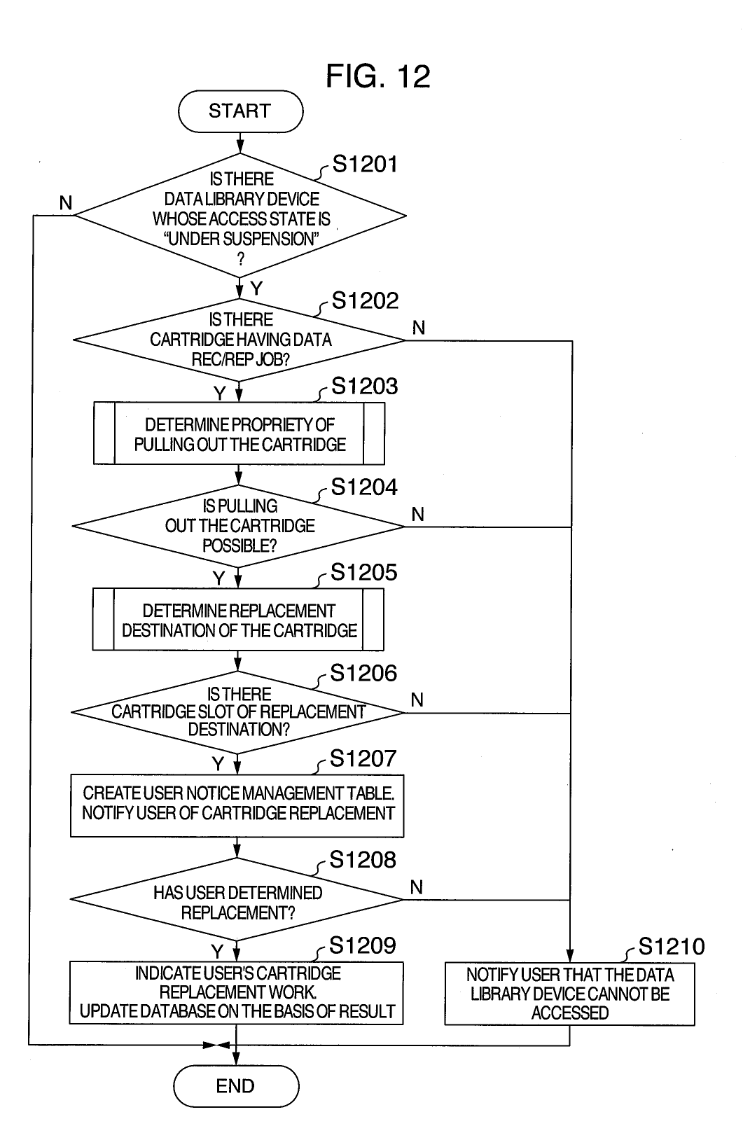

In step S1103, the data library device management program 310 calls processing of pulling out a cartridge 107 in a data library device 101 to which data access is impossible due to occurrence of the fault and replacing another cartridge 107 in a data library device to which data access is possible with the cartridge 107 pulled out. Details of the processing are shown in FIG. 12.

FIG. 12 shows processing of determining whether to pull out a cartridge 107 from the data library device 101 in which the fault has occurred and whether to replace a cartridge 107 in another data library device 101 operating normally with the cartridge 107 pulled out. This is processing executed by the data library device management program 310 in the server 115.

In step S1201, the data library device management program 310 determines whether there is a data library device 101 for which the data library device access state is “under suspension” due to a fault, on the basis of the data library device access state 3146 in the data library device fault state table 314. If there is a data library device 101 for which the data library device access state 3146 in the data library device fault state table 314 stores “under suspension” as a result of the step S1201, the processing proceeds to S1202.

If there isn't a data library device 101 for which the access state is “under suspension” as a result of the step S1201, the present processing is finished. The data library device 101 works in a degraded state in which data access is possible although a fault has occurred.

Then, in step S1202, it is determined whether there is data access to an optical disc in the cartridge 107 in the faulty data library device 101 determined in step S1201. The data library device management program 310 refers to the data read/write job management table 315, and determines whether there is a data recording/reproducing job ID for a cartridge 107 belonging to the faulty data library device 101.

If there is even one cartridge having the data recording/reproducing job ID as a result of the step S1202, the processing proceeds to S1203. This is a state in which there is a remaining instruction of data recording/reproducing to a cartridge 107 in the data library device 101 to which data access is impossible due to the fault. Data access to the cartridge 107 is made possible by pulling out the cartridge 107 from the faulty data library device 101 and replacing a cartridge 107 in another data library device 101 to which data access is possible with the cartridge 107 pulled out. If there isn't any cartridge having the data recording/reproducing job ID as a result of the step S1202, the processing proceeds to S1210.

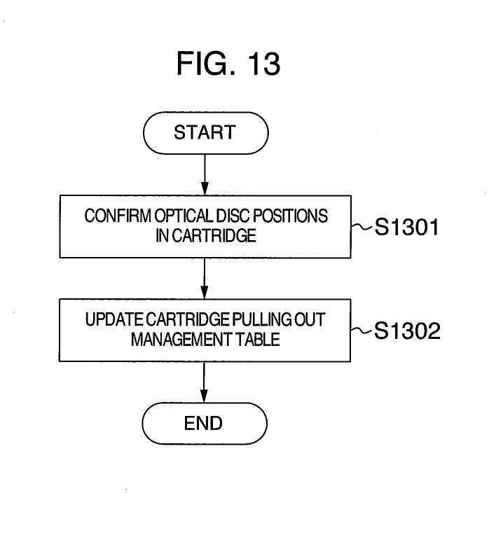

Then, in step S1203, the data library device management program 310 calls processing of determining propriety of pulling out the cartridge 107 from the data library device 101 in which the fault has occurred. The processing of determining propriety of pulling out the cartridge 107 will be described in detail later with reference to FIG. 13.

Then, in step S1204, processing is branched on the basis of a result of the determination in step S1203. If the cartridge 107 can be pulled out as a result of the processing of determining propriety of pulling out the cartridge 107, the processing proceeds to S1205.

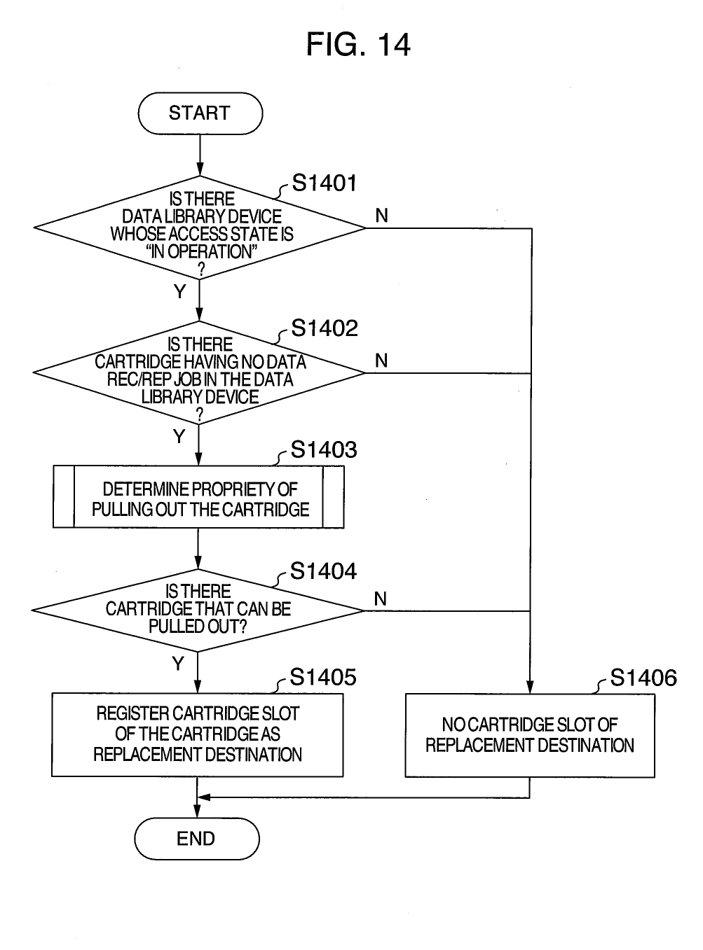

If the cartridge 107 cannot be pulled out as a result of the processing of determining propriety of pulling out the cartridge 107, the processing proceeds to S1210. Then, in step S1205, it is determined whether there is a cartridge slot 102 that is a replacement destination of the cartridge 107. The determination in the present processing will be described in detail later with reference to FIG. 14.

Then, in step S1206, the processing is branched on the basis of a result of determination in step S1205. If there is a cartridge slot 102 of the replacement destination as a result of the determination whether there is a cartridge slot 102 that is the replacement destination of the cartridge 107, the processing proceeds to S1207.

If there isn't a cartridge slot 102 of the replacement destination as a result of the determination whether there is a cartridge slot 102 that is the replacement destination of the cartridge 107, the processing proceeds to S1210.

Then, in step S1207, the user notice management table 310 is created newly, and a result thereof is displayed on the display device 118.

Information of the replacement source and the replacement destination is registered in the user notice management table 319. For example, information concerning the cartridge 107 scheduled to be pulled out and determined in the processing of determining propriety of pulling out the cartridge 107 is registered in the “replacement source” on the basis of the data library device management table 313 and the data library device fault state table 314. A cartridge slot 102 stored as a result of determining whether there is a cartridge slot 102 of replacement destination in step S1205, and information concerning the cartridge slot 102 are registered in the “replacement destination” on the basis of the data library device management table 313 and the data library device fault state table 314. In addition, the job end scheduled time (without cartridge replacement) 3196 is calculated from the maintenance completion estimated time 3174 and the job execution scheduled time 3156. Furthermore, the job end scheduled time (with cartridge replacement) 3197 is calculated from the job execution scheduled time 3156 and time required for cartridge replacement. In the present embodiment, the time required for cartridge replacement is stored previously in the maintenance component table 316 in the server 115 as exchange time of a maintenance component in a fixed value form.

In a case where there is a plurality of cartridge slots of replacement destination, the plurality of cartridge slots of replacement destination are registered in the user notice management table 319 as the replacement destination in step S1207. In step S1208, it is also possible to display the plurality of cartridge slots 102 of replacement destination to the user and cause the user to select a cartridge slot 102 to be utilized as the replacement destination. At that time, information concerning the plurality of cartridge slots 102 of replacement destination may be displayed to the user additionally. For example, every cartridge slot 102, information of “pulling out is possible” or “not yet inserted,” which is information of cartridge pulling out propriety, is displayed additionally.

By the way, the data library device management program 310 may narrow down candidates of replacement destination from the plurality of cartridge slots 102 of replacement destination or provide the plurality of cartridge slots 102 of replacement destination with priorities at the time of display. Furthermore, when there is a plurality of data library devices 101 of replacement destination candidates, a data library device 101 for which information that a cartridge 107 is not yet inserted into a cartridge slot 102 is stored may be determined preferentially as the replacement destination in S1205. Or in S1207, it is possible to refer to information of cartridge pulling out propriety of cartridge slots 102 and display cartridge slots 102 in which a cartridge is not yet inserted with highest priority.

In step S1207, the work notice to user 3198 in the user notice management table 319 is generated and a result thereof is displayed on the display device 118. As for the generation of the work notice to user 3198, a composition that can be understood by the user easily is generated on the basis of the information stored in the user notice management table 319. For example, in a case where information concerning the cartridge slot 102 of replacement source is stored in the user notice management table 319, a user notice of cartridge pulling out work for the cartridge 107 in the cartridge slot 102 in the data library device 101 is generated in the work notice to user 3198. In the same way, in a case where information concerning cartridge slots 102 of replacement destination is stored in the user notice management table 319, a cartridge slot 102 in a data library device 101 of replacement destination is specified and indication of insertion work of the cartridge 107 pulled out into the specified cartridge slot 102 is generated in the work notice to user 3198. In addition, in a case where there is a cartridge 107 inserted in the cartridge slot 102 in the data library device 101 of replacement destination when generating indication of the insertion work, a user notice may be generated to cause the user to conduct pulling out work of the cartridge inserted in the cartridge slot 102 before insertion work of the cartridge 107 pulled out.

In addition, in a case where there is stored information concerning the cartridge slot 102 of replacement source, a difference in job end time between the case where the cartridge is pulled out from the cartridge slot 102 and the cartridge in replaced in another cartridge slot 102 and a case where replacement is not conducted may be displayed in the work notice to user 3198. At this time, information based upon the job end scheduled time (without cartridge replacement) 3196 and the job end scheduled time (with cartridge replacement) 3197 is displayed.

In step S1207, the user watches the user notice management table 319 displayed on the display device 118 in the server 115. In step S1208, the user determines whether to execute the cartridge replacement work. The user inputs a result of determination from the user I/F unit 309. Processing is branched on the basis of a result of input from the user. If the result of step S1208 is that the cartridge replacement work is to be executed, the processing proceeds to step S1209. If the result of step S1208 is that the cartridge replacement work is to be executed, the processing proceeds to step S1209. If the result of step S1208 is that the cartridge replacement work is not to be executed, the processing proceeds to step S1210.

Then, in step S1209, work of actually detaching the cartridge 107 from the data library device 101 and work of inserting the detached cartridge 107 into a cartridge slot 102 in the data library device 101 of replacement destination are conducted. The present work is supposed to be conducted artificially by a worker nominated by the user. As a matter of course, it is also possible to automate the work conducted until the cartridge is detached. In that case, the server 115 issues a detachment instruction. In the data library device 101, steps of unlocking the door of the data library device 101 and executing cartridge detaching processing are executed.

During the present step, the server 115 explicitly causes data access of data recording or data reproducing to optical discs belonging to cartridges 107 of replacement source and replacement destination to be stopped. After the present step is finished, the data access is resumed.

By the way, the data library device that has received an instruction from the server 115 may support the worker's cartridge replacement work. For example, an LED in the information display unit 104 in a data library device 101 that indicates the cartridge 107 to be pulled out may be flashed to decrease work mistakes. It is also possible to display a result on the display device 118 in the server 115 or the information display unit 104 in the data library device 101 and prepare an interactive I/F indicating next work, every step of cartridge pulling out and replacement work.

Finally, the data library device management table 313, the data read/write job management table 315, and the cartridge pulling out management table 318 are updated to conform to the change of the cartridge 107 inserted into the cartridge slot 102 as a result of the cartridge replacement work.

FIG. 13 is a flow of processing of determining in S1203 propriety of pulling out the cartridge 107 from the data library device 101 stopped in data access due to occurrence of a fault. This is processing executed by the data library device management program 310 in the server 115.

By the way, the present processing flow is also a processing flow of determining in S1403 propriety of pulling out a cartridge of replacement destination of the cartridge 107 pulled out from the data library device 101 stopped in data access due to occurrence of a fault.

First, in step S1301, the data library device management program 310 refers to the cartridge pulling out management table 318. The data library device management program 310 confirms where the optical disc 108 in the cartridge 107 in the data library device 101 is stored at the present time as a result of S1201 and S1202 in FIG. 12 by referring to the “optical disc position” in the cartridge pulling out management table 318. If all optical discs 108 belonging to the cartridge 107 are stored in the cartridge, the data library device management program 310 determines that the cartridge can be pulled out from the data library device 101. If even one of the optical discs 108 belonging to the cartridge 107 is stored in a place other than the cartridge, it is determined that the cartridge 107 cannot be pulled out from the data library device 101. By the way, a cartridge slot in which a cartridge 107 is not inserted is determined to be non-inserted. In this case, the cartridge slot is determined to be a cartridge slot 102 of replacement destination in determining whether a cartridge of replacement destination can be pulled out. Details thereof will be described with reference to FIG. 14.

Then, in step S1302, the data library device management program 310 registers a result of determination of propriety of pulling out in step S1301 into the cartridge pulling out propriety 3186 in the cartridge pulling out management table 318.

FIG. 14 is a flow of processing of determining whether there is a cartridge slot 102 of replacement destination for the cartridge 107 pulled out from the data library device 101 stopped in data access due to occurrence of a fault. The processing is executed by the data library device management program in the server 115.

In step S1401, the data library device management program 310 determines whether there is a data library device 101 for which the “data library device access state” 3146 is “in operation” by referring to the data library device fault state table 314.

If there is a data library device 101 for which the “data library device access state” 3146 is “in operation” as a result of step S1401, the processing proceeds to S1402. If there isn't a data library device 101 for which the “data library device access state” 3146 is “in operation” as a result of step S1401, the processing proceeds to S1406.

Then, in step S1402, it is determined whether there is data access to an optical disc in the cartridge 107 in the data library device 101 determined in step S1401. The data library device management program 310 refers to the data read/write job management table 315 and determines whether there is a data recording/reproducing job ID for a cartridge belonging to the data library device 101.

If there isn't even one cartridge having the data recording/reproducing job ID as a result of step S1402, the processing proceeds to S1403. If there is even one cartridge having the data recording/reproducing job ID as a result of step S1402, the processing proceeds to S1406. This is a state in which an instruction of data recording/reproducing for the cartridge 107 in the data library device 101 remains. Since data access to the cartridge 107 is scheduled, the cartridge 107 cannot be taken out from the cartridge slot 102.

Then, in step S1403, the data library device management program 310 calls processing of determining propriety of pulling out the cartridge 107 from the data library device 101. The processing S1403 of determining propriety of pulling out the cartridge 107 has been described in detail with reference to FIG. 13. Then, in step S1404, the processing is branched on the basis of a result of determination in step S1403. If the cartridge 107 in the cartridge pulling out management table 318 is “pulling out is possible” or the cartridge 107 in the cartridge pulling out management table 318 is “not yet inserted,” the processing proceeds to step S1405. If the cartridge 107 in the cartridge pulling out management table 318 is “pulling out is impossible,” the processing proceeds to step S1406.

Then, in step S1405, the cartridge slot 102 in which the cartridge 107 that can be pulled out is stored as a cartridge slot 102 of replacement destination. Furthermore, the cartridge slot 102 in which the cartridge 107 is not yet inserted is stored as a cartridge slot 102 of replacement destination. In step S1406, it is determined that there isn't a cartridge slot 102 of replacement destination as a result of the above-described processing flow.

### Embodiment 2

In embodiment 2, in addition to embodiment 1, the cartridge 107 is pulled out from the library device 101 to which data access cannot be conducted due to a fault, on the basis of a utilization situation of optical discs and the cartridge 107 is inserted into the cartridge slot 102 in the data library device 101 of replacement destination to which data access is possible and consequently data access to the cartridge 107 is continued.

In embodiment 1; the cartridge 107 cannot be pulled out unless all optical discs are stored in the cartridge. In embodiment 2, however, it becomes possible to pull out the cartridge 107 according to utilization situation of optical discs even if all optical discs are not stored in the cartridge.

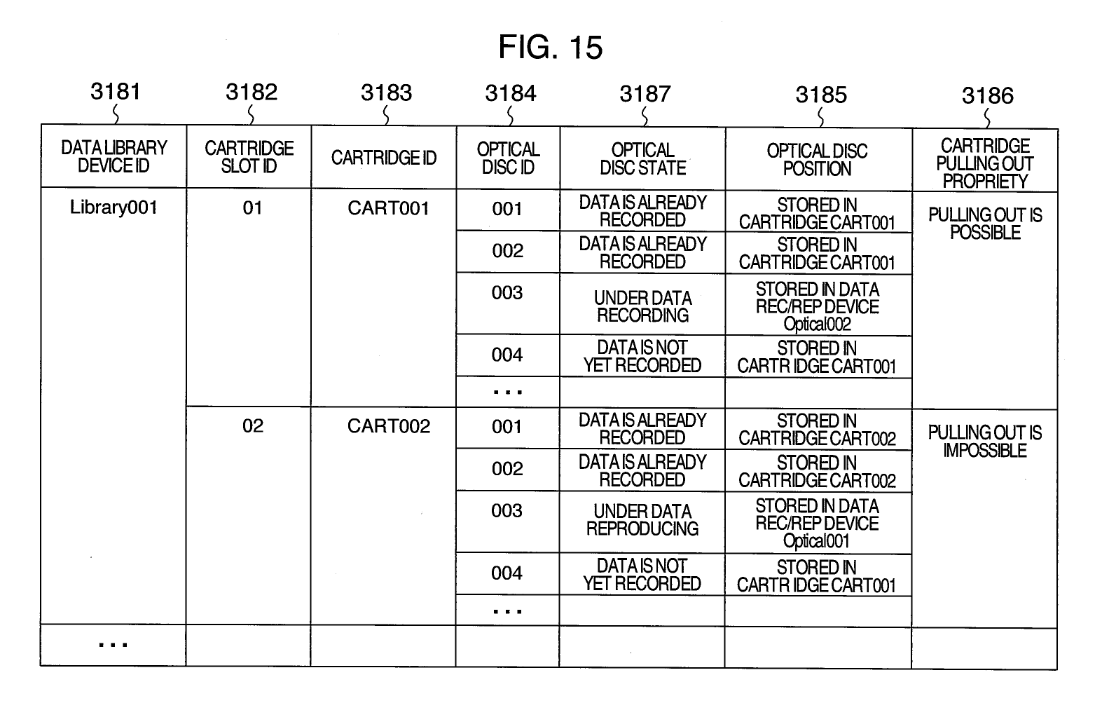

In embodiment 2, only a difference from embodiment 1 will be described. Specifically, the server 115 manages the utilization situations of all optical discs 108 stored in at least one data library device 101 and stores the utilization situations of all optical discs 108 into the cartridge pulling out management table 318. An example of the cartridge pulling out management table 318 in embodiment 2 is shown in FIG. 15. In FIG. 15, an optical disc state 3187 is added as compared with FIG. 9.

In the cartridge pulling out management table 318 in FIG. 15, the optical disc state 3187 is added every optical disc ID. The data read/write program 311 in the server 115 stores temporarily write data received from the host computer 120 into the memory 302 or the hard disc 117 and then records the data onto the optical disc 108 in the data library device 101. Furthermore, the data read/write program 311 in the server 115 reproduces data from the optical disc 108 in the data library device 101 in response to a data read instruction received from the host computer 120 and returns the data to the host computer 120.

At this time, the optical disc state is changed in accordance with the utilization states of optical discs. At the time of initial introduction of the data library device 101, all optical discs 108 are new articles, and registration is conducted as a state in which any data are not yet recorded.

When recording data on an optical disc 108 in the data library device 101, the data read/write program 311 selects an optical disc 108 that is “data is not yet recorded” in the optical disc state, from the cartridge 107. While the optical disc 108 is selected for data recording, taken out from the cartridge 107 by the optical conveyance device 106, and inserted in the data recording/reproducing devices 109 and 110, the optical disc state 3187 is changed to “under data recording.” If finally data recording is completed and the optical disc 108 is stored in the cartridge 107, the optical disc state is changed to “data is already recorded.”

In a case where data recording fails or is interrupted by some reason during data recording, the data read/write program 311 selects an optical disc 108 on which data is not yet recorded and which is different from the optical disc 108 under data recording, and records data on the optical disc 108 again.

By the way, an empty capacity of the optical disc 108 interrupted in data recording may be recorded. If a data quantity of the interrupted data recording is equal to the empty capacity or less, the interrupted optical disc may be selected again and a continuation of data may be recorded. In this case, the optical disc state 3187 is set to “data is already recorded (interrupted)” and handled in the same way as “data is already recorded.”

When reproducing data from the optical disc 108 in the data library device 101, the data read/write program 311 selects an optical disc 108 that is “data is already recorded” in the optical disc state from the cartridge 107. While the optical disc 108 is selected for data reproducing, taken out from the cartridge 107 by the optical conveyance device 106, and inserted in the data recording/reproducing devices 109 and 110, the optical disc state is changed to “under data reproducing.” If finally data reproducing is completed and the optical disc 108 is stored in the cartridge 107, the optical disc state is changed to “data is already recorded.”

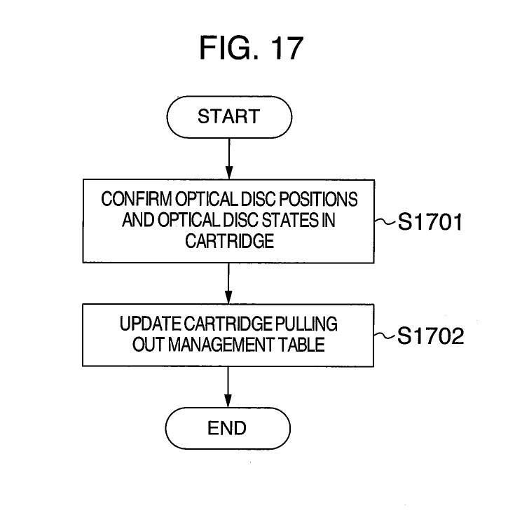

FIG. 17 is a flow of processing of determining in S1203 in embodiment 2 propriety of pulling out the cartridge 107 from the data library device 101 stopped in data access due to occurrence of a fault. This is processing executed by the data library device management program 310 in the server 115.

By the way, the present processing flow is also a processing flow of determining in S1403 propriety of pulling out a cartridge of replacement destination of the cartridge 107 pulled out from the data library device 101 stopped in data access due to occurrence of a fault.

First, in step S1701, the data library device management program 310 refers to the cartridge pulling out management table 318. If all optical discs 108 belonging to the cartridge 107 are stored in the cartridge, the data library device management program 310 determines that the cartridge can be pulled out from the data library device 101. Or if the optical disc states of optical discs 108 stored in the optical disc conveyance device 106 and the data recording/reproducing devices 109 and 110 except the cartridge are only “under recording,” it is determined that the cartridge can be pulled out.

If even one of the optical discs 108 belonging to the cartridge 107 is “under reproducing” in the optical disc state, it is determined that the cartridge 107 cannot be pulled out from the data library device 101. By the way, a cartridge slot in which a cartridge 107 is not inserted is determined to be non-inserted.

Then, in step S1702, the data library device management program 310 registers a result of determination of propriety of pulling out in step S1701 into the cartridge pulling out propriety 3186 in the cartridge pulling out management table 318.

In addition, in embodiment 2, information described hereafter is added when creating the user notice management table 319 newly and displaying a result on the display device 118 in S1207 in embodiment 1.

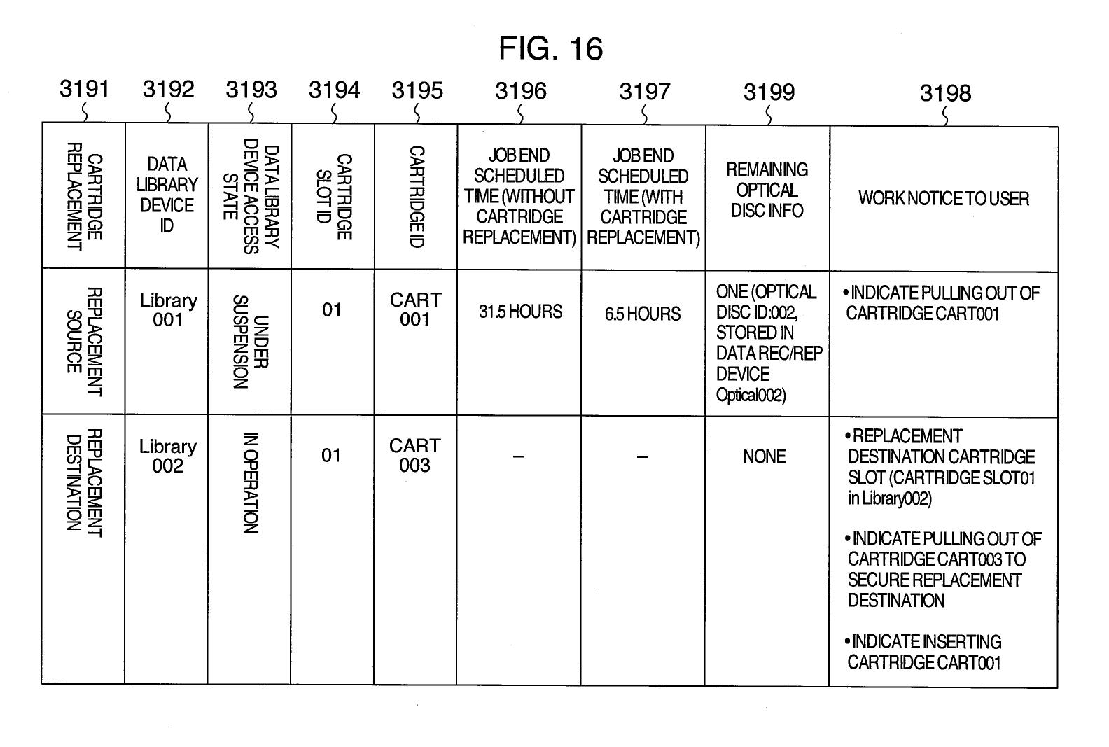

A user notice management table 1601 created newly is shown in FIG. 16. In FIG.

16, remaining optical disc information 3199 is added as compared with FIG. 10. When a cartridge is pulled out, optical discs 108 remain not within the cartridge pulled out but in the data library device 101 in some cases. In this case, information of the optical discs 108 is stored in the remaining optical disc information 3199. Specifically, the number of optical discs remaining in the optical disc conveyance device 106 and the data recording/reproducing devices 109 and 110 within the data library device 101 when the cartridge is pulled out, and disc IDs and storage positions of the remaining optical discs are registered. Furthermore, capacities and media classifications of the remaining optical discs may be registered.

As a result, the server 115 can notify the user of information of the optical discs left in the data library device 101 by pulling out the cartridge 107. The user can confirm that there are optical discs left by pulling out the cartridge 107 and determine whether to execute cartridge replacement work. In addition, the maintenance person may be notified of information of remaining optical discs 108 although not illustrated. When repairing the data library device 101 in which a fault has occurred, the maintenance person withdraws the remaining optical discs 108 on the basis of the information.

### Embodiment 3

In step S1205 in embodiment 1, it is determined whether there is a cartridge slot 102 of replacement destination of the cartridge 107. In embodiment 3, at the time of the determination, preventive maintenance information of the cartridge is referred to, and a cartridge slot 102 in a data library device 101 expected to be little in fault occurrence is determined as a cartridge slot 102 of replacement destination.

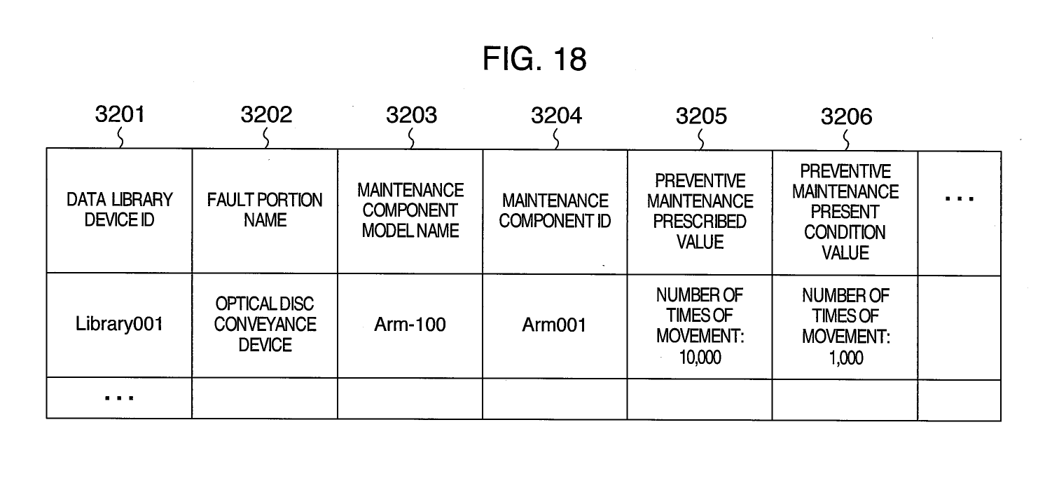

In embodiment 3, only a difference from embodiment 1 will be described. In the present embodiment, the memory 105 in the data library device 101 retains a preventive maintenance information table 320 shown in FIG. 18 although not illustrated. The preventive maintenance information table 320 includes a data library device ID 3201, a fault portion name 3202, a maintenance component model name 3203, a maintenance component ID 3204, a preventive maintenance prescribed value 3205, and a preventive maintenance present condition value 3206. Among them, the data library device ID 3201, the fault portion name 3202, the maintenance component model name 3203, the maintenance component ID 3204, and the preventive maintenance prescribed value 3205 are values set by a vendor at the time of shipping of the data library device 101 or at the time of initial introduction. If the configuration of the device is changed, those values are updated. The data library device ID 3201, the fault portion name 3202, the maintenance component model name 3203, and the maintenance component ID 3204 are the same as those in the data library device management table 313, the maintenance component table 316, and the maintenance schedule table 317. As for the preventive maintenance prescribed value 3205, values of a utilization term and the number of times of utilization prescribed every maintenance component model name are stored. In a case where each component in the data library device is utilized with a utilization term and the number of times of at least the prescribed values, the possibility that a fault will occur in the component becomes high. For example, there are the number of times of rotation of the motor in the optical disc conveyance device 106, the number of times of insertion of the data recording/reproducing devices 109 and 110 and the optical disc 108, the number of times of the cartridge 107 in the cartridge slot 102, and so on. As for the preventive maintenance present condition value 3206, the utilization term and the number of times of each component in the data library device 101 at the present time are stored. As for the values, the data library device 101 always monitors the utilization term and the number of times of each component at the present time and notifies the server 115 thereof. Or the server 115 may communicate with the data library device 101 periodically and collect the values.

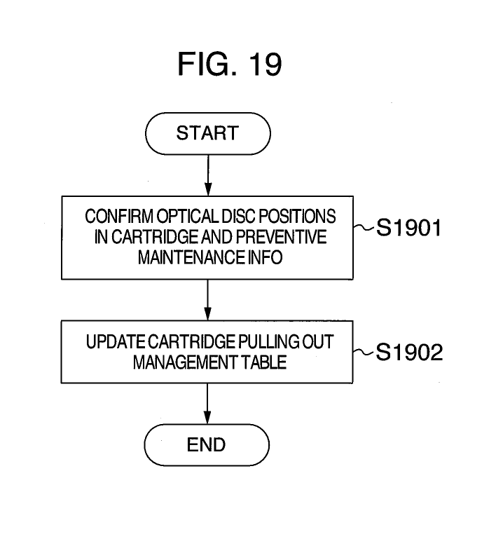

As for the determination of propriety of pulling out of cartridge of replacement destination in S1403 called from step S1205 in embodiment 1, processing shown in FIG. 19 is executed. The data library device management program 310 refers to the preventive maintenance information table 320 in addition to the cartridge pulling out management table 318.

In step S1901, the data library device management program 310 first refers to the cartridge pulling out management table 318 in the same way as embodiment 1, and determines propriety of pulling out the cartridge of replacement destination. In a case where there is at least one cartridge slot 102 that is “pulling out is possible” or “not yet inserted” in cartridge pulling out propriety, the data library device management program 310 refers to the preventive maintenance information table 320, and selects a cartridge slot 102 in a data library device 101 that is low in possibility of fault occurrence on the basis of the preventive maintenance present condition value 3206 and the preventive maintenance prescribed value 3205. Specifically, the data library device management program 310 selects a cartridge slot 102 that is large in difference between the preventive maintenance present condition value 3206 and the preventive maintenance prescribed value 3205.

Then, in step S1902, the data library device management program 310 registers a result of determination of pulling out propriety in step S1901 into “cartridge pulling out propriety” in the cartridge pulling out management table 318. In S1207, the data library device management program 310 registers the cartridge slot 102 of replacement destination selected in step S1901 into the user notice management table 319.

By the way, in step S1901, a plurality of cartridge slots 102 of replacement destination may be registered into the user notice management table 319 without selecting a cartridge slot 102 in a data library device 101 that is low in possibility of fault occurrence. In that case, information of the preventive maintenance present condition value 3206 and the preventive maintenance prescribed value 3205 may be displayed to the user and in step S1208 the user may be caused to select a cartridge slot 102 to be utilized as the replacement destination from among a plurality of cartridge slots 102 of replacement destination.

The present invention is not restricted to the above-described embodiments 1 to 3, but various modifications are included. For example, the embodiments have been described in detail to facilitate understanding the present invention. It is not always necessary to provide all described configurations. Furthermore, it is possible to replace a portion of a configuration of an embodiment with a configuration of another embodiment. It is also possible to add a configuration of another embodiment to a configuration of an embodiment. Furthermore, with respect to a portion of a configuration of each embodiment, it is possible to add, remove, or replace another configuration.

A portion or all of the above-described configuration, function, processing unit and processing means may be implemented with hardware by, for example, designing with an integrated circuit. The above described configuration and function may be implemented with software by using a processor which interprets and execute a program implementing each function. Information of a program, a table, a file and the like can be placed in a recording device such as a memory, a hard disc, or an SSD (Solid State Drive) or recording media such as an IC card, an SD card, or a DVD.

As for control lines and information lines, lines considered to be necessary in description are shown. All control lines and information lines on a product are not shown. As a matter of fact, it may be considered that almost all configurations are connected mutually.

It should be further understood by those skilled in the art that although the foregoing description has been made on embodiments of the invention, the invention is not limited thereto and various changes and modifications may be made without departing from the spirit of the invention and the scope of the appended claims.

1. A data archive system including data library devices and a server connected to the data library devices,
each of the data library devices comprising:
a recording media storage unit for storing recording media, the recording media storage unit being capable of being attached and detached;
a recording media storage destination for storing the recording media storage unit;
a data recording/reproducing unit for recording data onto the recording media or reproducing data from the recording media; and
a recording media conveyance unit for conveying the recording media between the recording media storage unit and the data recording/reproducing unit and conducting delivery,
the server comprising a server control unit to control operation of the server and operation of the library devices,
wherein
the server control unit manages the data library devices by using a first information table for registering fault information concerning abnormal operation of the data library devices and a second information table for registering position information of the recording media, and
in a case where the server control unit has identified a first one of the data library devices that cannot be controlled on the basis of the first information table, the server control unit determines whether the recording media storage unit can be detached from the first data library device on the basis of the second information table.

2. The data archive system according to claim 1, wherein in a case where the server control unit has determined that the recording media storage unit can be detached from the first data library device, the server control unit identifies a second one of the data library devices that can be controlled by the server control unit, on the basis of the first information table, and determines on the basis of the second information table whether the recording media storage unit can be detached from the second data library device.

3. The data archive system according to claim 2, wherein the server control unit identifies a third one of the data library devices into which a recording media storage unit determined to be detachable from the first data library device can be inserted, on the basis of a result of determination of detachment of the recording media storage unit from the second data library device.

4. The data archive system according to claim 1, wherein
the server is connected to an output device which outputs information, and
in a case where the server control unit determines that the recording media storage unit can be detached from the first data library device, the server control unit exercises control to output information concerning detachment of the recording media storage unit determined to be detachable into the output device.

5. The data archive system according to claim 3, wherein in a case where the server control unit has identified the third data library device, the server control unit exercises control to output information concerning insertion of the recording media storage unit determined to be detachable from the first data library device into the third data library device, into the output device.

6. The data archive system according to claim 1, wherein
the server control unit manages data library devices by using a third information table in which a job of recording/reproducing data onto/from the recording media is registered, and
the server control unit determines whether the recording media storage unit can be detached from the first data library device on the basis of the third information table.

7. The data archive system according to claim 2, wherein
the server control unit manages data library devices by using a third information table in which a job of recording/reproducing data onto/from the recording media is registered, and
the server control unit determines whether the recording media storage unit can be detached from the second data library device on the basis of the third information table.

8. The data archive system according to claim 1, wherein
the server control unit manages data library devices by using a third information table in which utilization state information concerning recording and reproducing of the recording media is registered, and
the server control unit determines whether the recording media storage unit can be detached from the first data library device on the basis of the third information table.

9. The data archive system according to claim 2, wherein
the server control unit manages data library devices by using a third information table in which utilization state information concerning recording and reproducing of the recording media is registered, and
the server control unit determines whether the recording media storage unit can be detached from the second data library device on the basis of the third information table.

10. The data archive system according to claim 3, wherein
the server control unit in the server manages data library devices by using a third information table in which preventive maintenance information of the data library devices is registered, and
the server control unit identifies a third one of the data library devices into which the recording media storage unit determined to be detachable from the first data library device is inserted.

11. The data archive system according to claim 4, wherein
the server control unit manages data library devices by using a third information table in which information concerning maintenance of the data library devices is registered, and
the server control unit predicts a first state of the data archive system in a case where detachment of the recording media storage unit determined to be detachable from the first data library device and insertion of the recording media storage unit into a third one of the data library devices are executed, and a second state of the data archive system in a case where the detachment and the insertion are not executed, and outputs information concerning the first state of the data archive system and information concerning the second state of the data archive system to the output device.

12. The data archive system according to claim 3, wherein in a case where it is determined that the recording media storage unit is not stored in the recording media storage unit storage destination in the second data library device as a result of determination of detachment of the recording media storage unit from the second library device, the server control unit identifies the second data library device determined that the recording media storage unit is not stored therein as a third one of the data library devices.

13. The data archive system according to claim 3, wherein
in a case where there are the second data library device determined that the recording media storage units are stored in all of the recording media storage unit storage destinations and the second data library device determined that the recording media storage units are not stored in the recording media storage unit storage destinations as a result of determination of detachment of the recording media storage unit from the second library device,
the server control unit identifies the second data library device determined that the recording media storage units are not stored as a third one of the data library devices.
